(19) United States
(12) Patent Application Publication
(10) Pub. No.: US 2015/0329346 A1
(43) Pub. Date: Nov. 19, 2015

(54) SYSTEMS FOR MONITORING AND DISPLAYING INFORMATION FOR BEVERAGE DISPENSING SYSTEMS

(71) Applicant: Rebot R&D, LLC, Los Alamos, NM (US)

(72) Inventor: Rebecca L.E. Miller, Los Alamos, NM (US)

(73) Assignee: Rebot R&D, LLC, Los Alamos, NM (US)

(21) Appl. No.: 14/280,409

(22) Filed: May 16, 2014

(51) Int. Cl. B67D 1/08

(52) U.S. Cl. CPC B67D 1/0877; B67D 1/0874

(57) ABSTRACT

A system has a tap handle that includes a housing, a display disposed in the housing, a processor in communication with the display, and a remote device input in communication with the processor. The processor receives a signal from at least one remote sensor. The processor also receives a signal from either or both of a scale and a position sensor. The scale has a scale output in communication with the remote device input. The position sensor is in communication with the processor and detects a position of the tap handle.

In a commercial arrangement for dispensing carbonated beverages, typically those used in bars and restaurants, the tap handle is a specialty and sometimes very elaborate item that is manufactured for the purpose of labeling that particular brand or style of beverage. Homebrewers and microbrewers of alcoholic and non-alcoholic carbonated beverages make products in small batches, however, possibly never repeating the same recipe. This creates an issue when it comes time to dispense the brewed beverages, particularly in a scenario where the contents of multiple batches are being tapped from a common location, such as a tap tower. Individual tap handles must be labeled, but due to the short term of application, e.g., the time required to consume one batch of beverage, it may not make sense to manufacture an attractive and informative dedicated tap handle. In answer to an ever-changing product lineup, the current solutions employed by homebrewers and microbrewers include dry erase and chalkboard labels on tap handles, adhesive labels, re-usable generic tap handles, erasable chalkboards or dry-erase boards mounted near the taps, and other solutions.

It is also commonly desirable to track the volume remaining in a beverage reservoir such as a keg. Several methods are currently used to track the liquid level in a keg, and the conservation of mass approach is probably the most precise of these methods. Homebrewers generally perform this method by taking an initial tare weight for the keg and then taking weight measurements over time as beverage is removed. The volume remaining in the keg is calculated by dividing the weight of the liquid by the density of the brew. For homebrewers, this often means that a keg weighing perhaps 40 pounds must be removed from the dispensing location, such as a kegerator, sometimes even requiring removal of liquid or gas lines. The simplicity of the conservation of mass approach is offset both by its inconvenience and errors that arise from poor measurement techniques and an incomplete characterization of the system, such as its inability to account for the mass of gas used in carbonation and dispensing of the beverage.

Another common measurement performed by homebrewers and microbrewers involves the amount of carbonation in a particular beverage. The amount of carbonation is important because it affects not only the appearance and mouth-feel of the beverage, but may also affect the longevity and taste as a result of its ability to displace oxygen. In the case of forced carbonation rather than priming and secondary fermentation, the optimal amount of gas to be incorporated into a beverage is determined by the type of beverage being carbonated, in general 2.0 to 3.0 volumes of CO₂ for most beers and usually more for sodas. This value is often included in beer recipes, but there are general guidelines for the style of beverage, for example an India Pale Ale might be best when carbonated to 1.5-2.3 volumes of CO₂. A lookup table is then used to determine at what temperature and head-space pressure that amount of gas will be dissolved into the beverage and the settings on gas regulators and temperature control devices must be manually changed to match the desired conditions.

### SUMMARY

The present technology relates to a device used to sense, track, record and display liquid dispensation rates and totals in a beverage dispensing system such as those typically used for draft beer or soda and to present that information, along with high-quality graphics and text for the purpose of labeling a keg's contents, via an embedded graphical display. The display and settings of this tap handle may be programmed by a network connection, either wired or wireless, removable media, or other electronic storage or by direct interaction with the display. Interaction with the display may be done via a touch screen or other interaction modes such as keyboard and mouse, voice control, or any number of wireless communication protocols. Control of the display, usage settings and graphical representation of collected data and any external connections may be achieved by the use of an embedded computer or microprocessor or by external processing. Measurement of rate of dispensation, keg mass or weight, temperature, and other properties of the beverage and its environment is achieved through the use of a variety of wireless remote sensors that may communicate with the embedded microcontroller or external device responsible for control of the tap handle display. This data may then be stored locally on a device such as an SD card or may be transmitted via wired or wireless means to an external device, including network or cloud devices.

The technology provides an alterable means of labeling tap handles with high quality graphics and text. Embodiments allow for sensing, tracking, analysis, and representation of properties of the keg system for the purpose of tasks including, but not limited to, tracking the volume of beverage remaining in the beverage reservoir or keg, determining amount of gas dissolved in the beverage, tracking temperature of the beverage or other components of the system, tracking gas pressure, or tracking beverage dispensing as a function of time. Embodiments allow for the local display and remote transmittal of the collected data. Certain embodiments include the capability to store data relating to keg system properties either locally or remotely. Additionally, a user interface provides for changes in data that is collected, how it is displayed, changes in artwork or labeling, changes in how information is disseminated, or other interactions of the user with the device. Such information may be accessed either through direct interaction with the display via touch screen, keyboard, mouse or other standard local means of interaction, or remotely through use of wired or wireless means of communication. Particular embodiments may include a wireless connection with a remote computer through which connection the artwork on the display is altered and the properties of the keg are transmitted back to the remote computer, stored and then presented on a webpage, for example.

In one aspect, the technology relates to a system having: a tap handle having: a housing; a display disposed in the housing; a processor in communication with display; and a remote device input in communication with the processor for receiving a signal from at least one remote sensor; and at least one of a scale disposed remote from the tap handle, wherein the scale includes a scale output in communication with the remote device input; and a position sensor in communication with the processor for detecting a position of the tap handle. In an embodiment, the tap handle includes the position sensor. In another embodiment, a remote sensor has a remote sensor output in communication with the remote device input. In yet another embodiment, the remote sensor includes at least one of a gas pressure sensor, a temperature sensor, a fluid flow sensor, a viscometer, and an air sensor. In still another embodiment, the tap handle further includes a control input in communication with the processor.

In another embodiment of the above aspect, the position sensor includes at least one of a tilt sensor, an encoder, a proximity sensor, and an accelerometer. In an embodiment, the system further includes a user interface. In another embodiment, the user interface includes a graphic user interface, and wherein the display is adapted to display the graphic user interface.

In another aspect, the technology relates to a housing adapted to be secured to a beverage system tap; a processor disposed in the housing; at least one input in communication with the processor; and a display disposed in the housing and in communication with the processor, the display configured to display information related to a beverage type and information related to a beverage system condition. In an embodiment, the apparatus further includes at least one input in communication with the processor, wherein the beverage system condition is derived by the processor based upon information received from a sensor in communication with the at least one input. In another embodiment, the sensor is at least one of disposed in the housing and remote from the housing. In yet another embodiment, the sensor includes a plurality of sensors remote from the housing. In still another embodiment, the sensor includes a plurality of sensors disposed both in the housing and remote from the housing.

In another embodiment of the above aspect, the information related to the beverage type and the information related to the beverage system condition are displayed sequentially. In an embodiment, the information related to the beverage type and the information related to the beverage system condition are displayed simultaneously. In another embodiment, the graphic user interface is configured to display an alert condition. In yet another embodiment, the alert condition is derived by the processor based upon information received from a sensor in communication with the at least one input.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 depicts a beverage dispensing system in accordance with one embodiment of the present technology.

FIG. 2 depicts a beverage dispensing system in accordance with another embodiment of the present technology.

FIGS. 3A and 3B depict a tap handle in accordance with an embodiment of the present technology, in a first position and a second position, respectively.

FIG. 4 depicts one example of a suitable operating environment in which one or more of the present examples may be implemented.

FIG. 5 is an embodiment of a network in which the various systems and methods disclosed herein may operate.

### DETAILED DESCRIPTION

The technology pertains to a draft beverage dispensing system of the type used by homebrewers and microbrewers of carbonated beverages although embodiments of the technology may be utilized in facilities such as bars, restaurants, etc. The draft system includes a beverage reservoir, or keg, with a gas inlet and liquid outlet connected to a long dipper or pickup tube through which the beverage is dispensed. The function of this system relies on the ability of the brewer to produce a higher gas pressure in the headspace of the keg relative to the atmospheric pressure, less the head loss of the pickup tube and any connected tubing or fixtures. In general, this increased pressure may be achieved by a combination of secondary fermentation and/or forced carbonation. Secondary fermentation relies on the anaerobic activity of yeast to produce ethanol and carbon dioxide, CO₂, within the closed keg. Forced carbonation involves the addition of pressurized carbon dioxide gas via connection to a reservoir, such as a gas canister, of pressurized and regulated CO₂. Occasionally other gases are added to the beverage reservoir, as well, such as nitrogen gas, N₂. The pressure developed in the space inside the keg above the beverage, or headspace, then applies pressure to the surface of the liquid, which results in some of the gas being dissolved in the beverage. When the faucet connected to the liquid outlet of the keg is opened through manipulation of a lever or tap handle, a pressure difference between the headspace and atmospheric pressure results in liquid flowing up the pickup tube, through any connecting tubing and out the faucet. The following discussion involves aspects of the tap handle and properties of the entire keg system, including the keg environment.

The technologies described herein allow for high quality artwork and text to be added to the tap handle and to be altered as often as the brew on tap changes. An alterable means of labeling the tap handles with high quality graphics on an electronic display, such as an LCD or LED display, is incorporated into a tap handle having the standard tap faucet threaded connector. The handle may be capable of supporting the mechanical loads associated with activating the tap faucet while also allowing space for an electronics enclosure that is water-resistant or water-proof. The handle should be able to withstand the rigors associated with fouling in a wet environment and the cleaning agents used in such an environment, including, but not limited to, bleach and detergents. The enclosure may also provide a means of routing power to the enclosed electronics and an additional means of transmitting data both to the display and to an external location, either of which could be wired or wireless, requiring a penetration of the electronics enclosure outer wall in the case of wired power and data transmittal.

The technologies described herein track changes in beverage mass in situ, in real time, while also accounting for beverage temperature and gas constituents. An automated means of tracking keg liquid level utilizing sensors may be included to measure properties of the keg system or properties of the controls for that system, weight of the keg, temperature of the liquid in the keg, the pressure in the keg, or other factors. Additional sensors provide further capabilities for tracking a wide variety of properties of the keg system. The technologies described herein also determine the amount of gas, whether CO₂ or another gas such as N₂, dissolved in a beverage via first-principle calculations and direct measurement, preferably in an automated manner.

Displaying data relating to the properties of the keg system, both locally at the keg and at a remote location, incorporates an alterable display and processing done either in the electronics enclosure or at a remote location. If the data is processed locally for display, a processor is incorporated into the electronics enclosure. If data is processed remotely, at least a graphics processor is utilized in the electronics enclosure. The transmittal of data to a remote location incorporates either a wired or wireless communication system to an external device. Such system may include Bluetooth or other wireless modem and transmitter located in the electronics enclosure, or a communications port located in the enclosure with a penetration for the associated wire. Data storage may be provided by, for example, an SD card located within the enclosure, or a remote storage device such as a network attached hard drive or a cloud device.

A user interface having a touch screen and a wireless or wired means of communicating with an external device may be utilized. Control of the user interface may be achieved either through direct interaction with the tap handle display or by interaction with the remote device. An example of a remote device might be a user interface on a smart phone, tablet, or personal computer, via either direct wired or wireless communication or via a network connection, through which a user could interact with the tap handle display and connected sensors, controllers, or other devices.

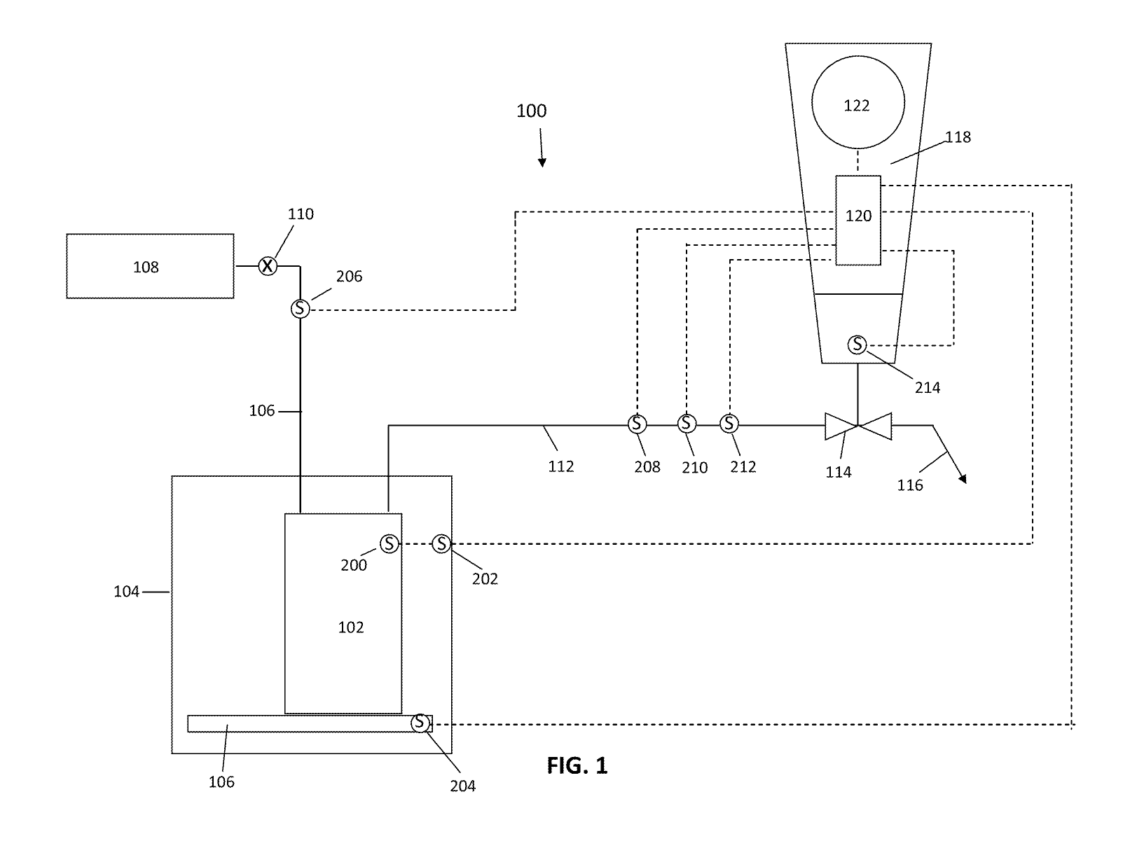

FIG. 1 depicts a beverage dispensing system 100 in accordance with one embodiment of the present technology. The system 100 includes a container or keg 102 containing a pressurized beverage, as described generally above. The keg 102 may be disposed in a chiller, kegerator, or other type of cooling system 104. A scale 106 is disposed in the kegerator 104, supporting the keg 102. The keg 102 is connected via a gas line 106, as described above, to a gas tank 108, which may include nitrogen, carbon dioxide, or other pressurizing gas. A shut-off valve 110 allows the gas line 106 to be isolated as required or desired to change or charge the gas tank 108. A fluid line 112 dispenses the pressurized fluid from the keg 102 to the tap 114, depicted here as a shut-off valve. When actuated, the tap 114 allows the beverage to be dispensed from a faucet 116. A tap handle 118 is connected to the tap 114 to actuate same. In this embodiment, the tap handle 118 includes a processor 120 and a display 122 in communication therewith. The processor 120 includes a number of remote device inputs for communicating with various sensors S described below.

The display 122 may include a graphic user interface that may display information about the system, as well as graphics specific to the beverage type being dispensed. This information may be displayed as required or desired for a particular application. For example, the graphic user interface may be programmed to display a beverage logo when the tap handle 118 is not being actuated, and to display a measure of volume while the tap handle 118 is actuated and beverage dispensed. Alternatively, the display 122 may display the beverage logo at all times, until a user activates the screen so as to display other information. The display may also display a beverage logo and system condition sequentially (or simultaneously, depending on the size of the logo, system condition information displayed, or other factors). The display 122 may also display alert or alarm conditions due to undesirable temperatures, the presence of air in the fluid line 112, or low pressure in the gas tank 108, for example.

FIG. 1 depicts a basic embodiment of a system 100 that utilizes only a single keg 102, gas tank 108, and tap 114. In other embodiments, multiple components may be utilized. For example, multiple kegs and scales may be included in a single kegerator, as required or desired for a particular application. Multiple kegerators, each containing one or more kegs may also be used. Additionally, multiple gas tanks may be connected to the system. Such an embodiment may be useful for brewers who utilize both nitrogen and carbon dioxide gas systems, depending on the type of beverage being dispensed. In such a case, a kegerator may have multiple penetrations for multiple gas lines, or each tank may be connected to a single gas line and activated as desired. Additionally, multiple taps may be utilized with a single keg. For example, a brewer may have a first tap disposed in a “private” location, such as a brew room where the brewing process takes place, and a second tap disposed in a nearby “public” location such as a bar room.

A variety of sensors S are depicted in FIG. 1. The sensors S are utilized by the system 100 to detect, measure, and otherwise monitor system and beverage conditions. Such sensors S may include, but are not limited to scales; air, gas, or liquid temperature sensors; air, gas, or liquid pressure sensors; air presence detectors; flow sensors; viscometers; position sensors; accelerometers; and so on. Each sensor S includes a remote sensor output in communication with the processor 120, via a wired or wireless connection. Remote sensors are those disposed remote from the tap handle 118 and include the majority of the sensors S depicted. In certain embodiments, certain sensors S may be disposed remote from or within the tap handle 118. For example, various types of position or tilt sensors 214, such as encoders, accelerometers, or proximity sensors, may be utilized. Certain of these sensors may be disposed in the tap handle 118 (an accelerometer, for example) or remote from the tap handle 118 (a proximity sensor, for example). Exemplary sensors S utilized in certain embodiments of beverage dispensing systems such as those described herein are described below.

A fluid temperature sensor 200 is disposed in the keg 102 for monitoring temperature of the beverage contained therein. Alternatively or additionally, an air temperature sensor 202 is disposed in the kegerator 104. Utilizing the fluid temperature sensor 200 along with the air temperature sensor 202 provides redundancy and allows the processor 120 to detect potential failures of, e.g., the kegerator 104 before the quality of the beverage in the keg 102 is adversely affected. A force or pressure sensor 204 is disposed in the scale 106 and may be used to perform the conservation of mass calculations described above. A gas temperature and/or pressure sensor 206 is disposed on the gas line 106 for monitoring the gas tank 108. The fluid line 112 includes a viscometer 208, an air presence detector 210, and a flow sensor 212. Signals from the viscometer 208 may be utilized by the processor 120 to calculate, for example, fluid ethanol content or density. The air presence detector 210 may be used to detect the presence of air (or foam) in the liquid line 210, a condition that commonly occurs when the keg 102 is drained of fluid. Locating the air presence detector 210 proximate the keg 102 may enable the keg 102 to be changed more efficiently, before a significant length of the fluid line 112 is filled with foam. The flow sensor 212 may be used to detect the volumetric rate of flow of the fluid in the fluid line. This may be particularly useful when the tap 114 enables fluid flow at different flow rates. The position sensor 214 is disposed in the tap handle 118 and is described in more detail below. The various sensors S send signals to the processor 120, which performs the necessary calculations to monitor and display the various system conditions.

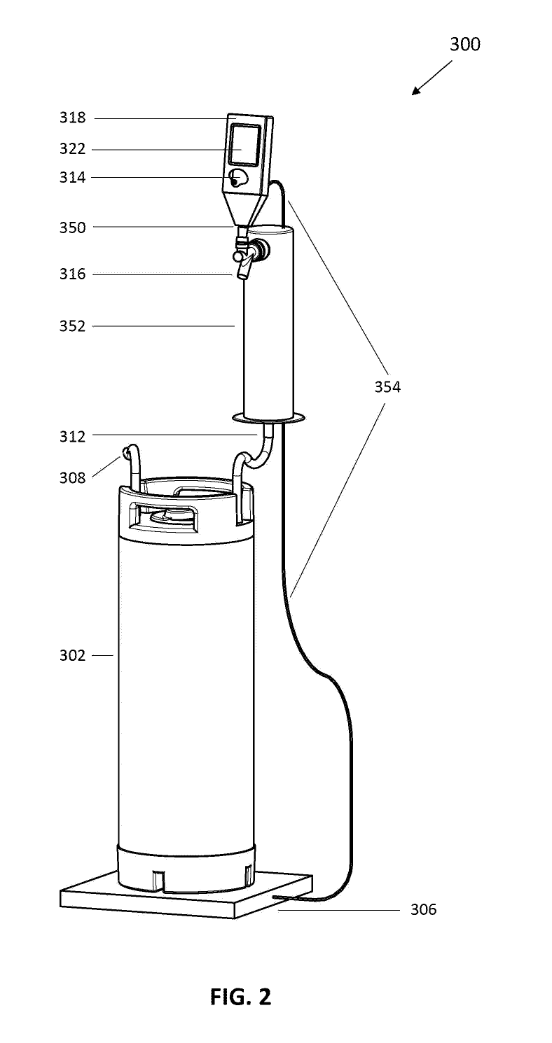

FIG. 2 depicts a beverage dispensing system 300 in accordance with another embodiment of the present technology. Certain of the components are described above with regard to FIG. 1 and utilize reference numerals similar to those of FIG. 1. Those components are therefore not necessarily described further below. It should be noted, however, that system components described in only one of the depicted systems may be incorporated into the other system, even though not presently depicted.

As in the system 100 of FIG. 1, the system 300 includes a tap handle 318 having a display 322 and threads 350 to connect the tap handle 318 to a tap faucet 316. The tap handle 318 includes an electronics enclosure and may contain several embedded sensors, such as a tilt sensor 314. The liquid, e.g., beer or soda, is dispensed through the tap faucet 316 which is controlled via deflection of the tap handle 318. A tap tower 352 elevates the tap faucet 316 above the surface of a keg 302 and provides an attachment point for the tap faucet 316. Additionally, a number of sensors on a fluid line 312 may be disposed in the tap tower 352. The keg 302 shown is one that would be typical in homebrew kegging arrangements and is commonly referred to as a Cornelius or Cornie Keg, though other types of kegging systems could be used with various embodiments of the technology. A gas line 308 is connected to the keg 302. A power and data wire 354 may be used to provide power to the tap handle 318 and the electronics enclosed therein as well as to transmit data to and from the various sensors and the tap handle 318. Though only two sensors are shown in this embodiment, the tilt sensor 314 and a scale 306, other sensors may be incorporated, such as those described above.

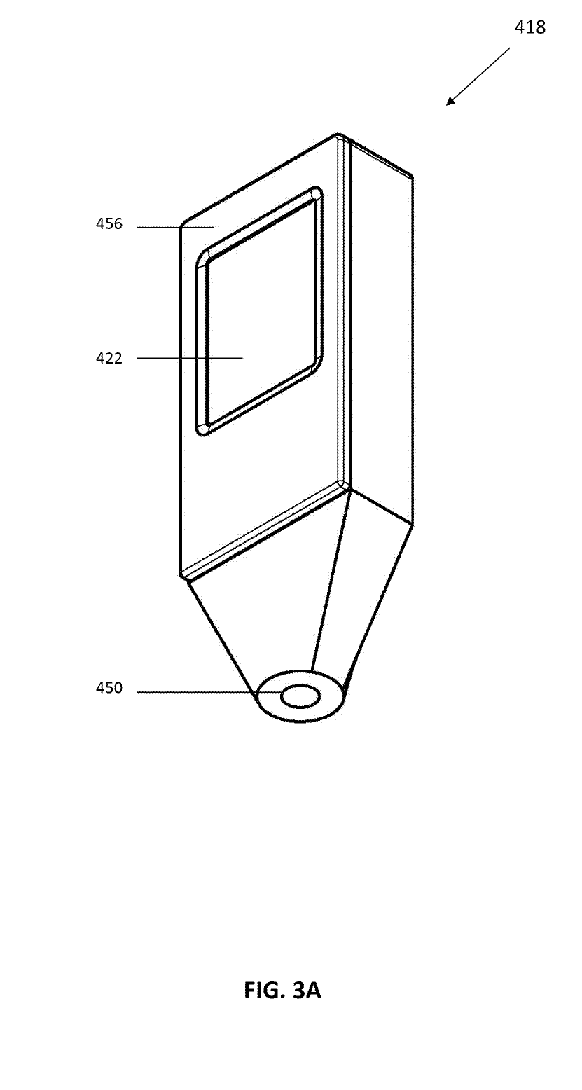

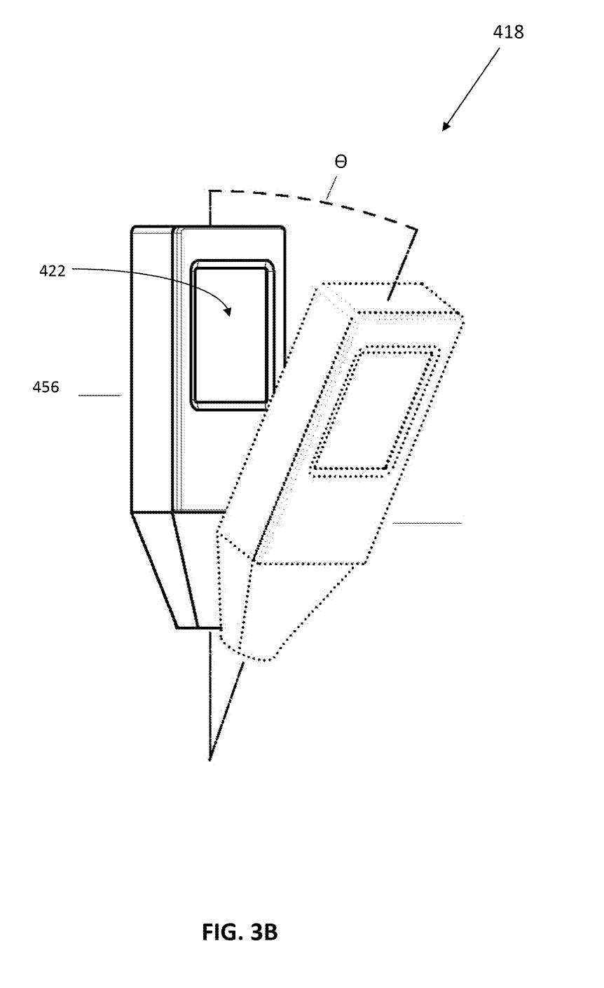

In an embodiment, a tilt sensor detects the rotation of a tap handle while liquid is being dispensed. FIGS. 3A and 3B depict a tap handle 400 in accordance with an embodiment of the present technology, in a first position and a second position, respectively. A tap handle 418 includes a housing 456 with a display 422. The housing 418 includes the associated graphics processor and/or microprocessor utilized to run the display 422, and a threaded connector 450 with standard threads for mating with a tap faucet.

An associated faucet, not shown, is opened by pulling the tap handle 418 toward the direction in which liquid exits the faucet, though other movements are possible. The angle θ between the two positions, and the time for which the tap handle 418 has been detected at angle θ, may be used to estimate the amount of liquid dispensed during the time period for which the tap handle 418 is detected. The angle θ is detected by the position sensor disposed in the tap handle 418. This information may be compared, for example, to information received from a fluid line flow sensor. A discrepancy between the two may be indicative of a sensor failure or other problem.

The method of determining liquid level using the data obtained from a tilt sensor involves first establishing a flow rate at θₘₐₓ, or maximum volumetric flow rate \dot{Q}ₘₐₓ. This is done by dispensing a pre-determined volume with the handle at position θₘₐₓ while tracking the dispense time, Δt. The relationship between deflection angle θ and the tap handle 418 and volumetric flow rate \dot{Q} depends on the style of valve used in the tap faucet, but may generally be considered to be proportional to A_{θ}tan(θ) and take the form of \dot{Q}=C₁\dot{m}A_{θ}tan θ, where A_{θ} is the open area of the faucet valve as a function of tap handle 418 deflection θ and C₁ is the constant associated with the geometry of the valve. With appropriate initial conditions, this equation is solved for the value of C₁. The problem is further simplified if beverage is always dispensed at θₘₐₓ, which is generally desirable, thus allowing tan θ to become a constant value, as well.

In an arrangement of the keg and faucet system that also includes a scale, such as depicted in FIGS. 1 and 2, the method for determining liquid level remaining utilizes fewer measurements and therefore has fewer independent variables with less error-prone measurement methods. The weight method of determining remaining liquid level in the keg also may necessitate weighing of the keg prior to use to determine a tare weight. The added accuracy of the liquid level tracking achieved through this method may make the addition of a scale desirable, for certain embodiments.

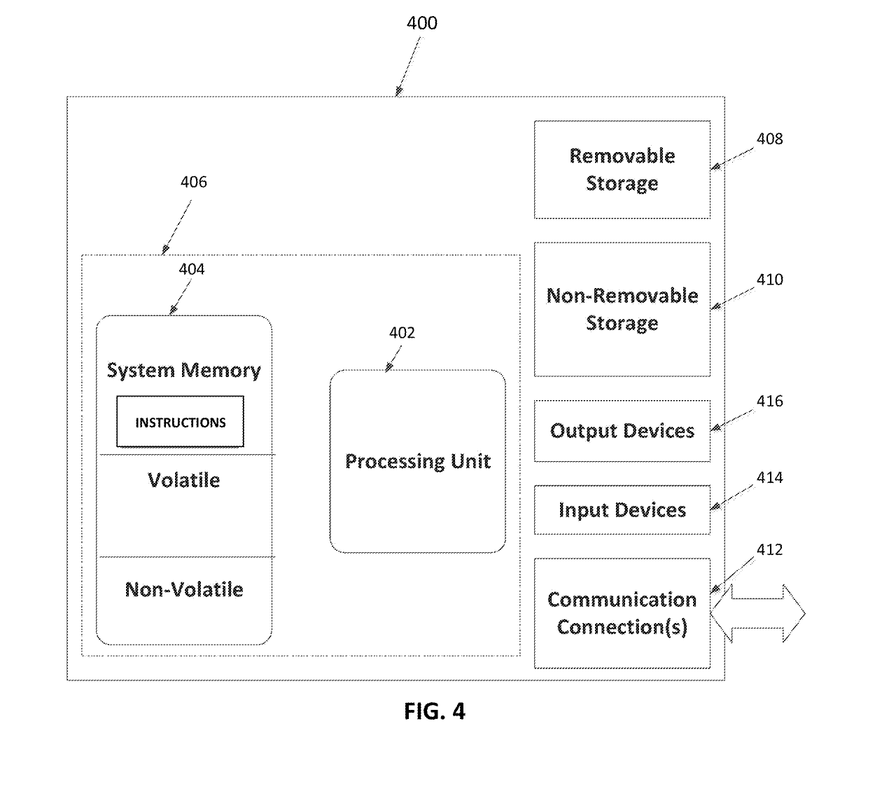

FIG. 4 depicts one example of a suitable operating environment 400 in which one or more of the present embodiments may be implemented. The components of this operating environment 400 may be incorporated into the tap handle described herein. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, smartphones, tablets, distributed computing environments that include any of the above systems or devices, and the like.

In its most basic configuration, operating environment 400 typically includes at least one processing unit 402 and memory 404. Depending on the exact configuration and type of computing device, memory 404 (storing, among other things, instructions to query, receive, and process the data from the various sensors described herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as touch screens, keyboard, mouse, pen, voice input, etc. and/or output device(s) 416 such as a display, speakers, printer, etc. Also included in the environment may be one or more communication connections, 412, such as LAN, WAN, point to point, Bluetooth, RF, etc.

Operating environment 400 typically includes at least some form of computer readable media. Computer readable media may be any available media that may be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other medium which may be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

In some embodiments, the components described herein comprise such modules or instructions executable by computer system 400 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 400 is part of a network that stores data in remote storage media for use by the computer system 400.

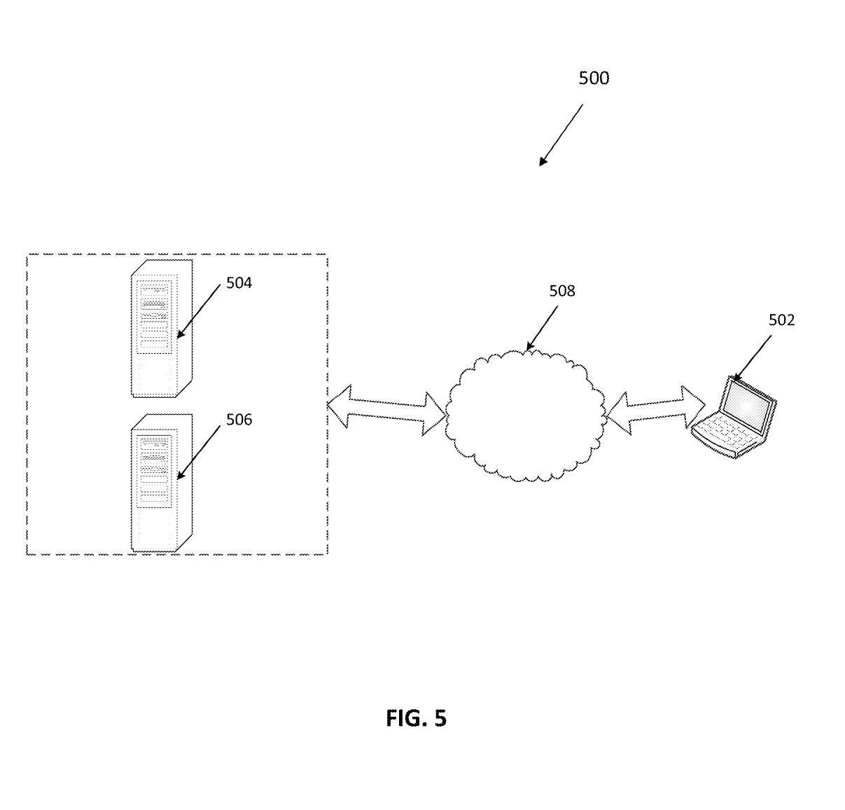

FIG. 5 is an embodiment of a network 500 in which the various systems and methods disclosed herein may operate. In embodiments, client device 502, may communicate with one or more servers, such as servers 504 and 506, via a network 508. In embodiments, the client device 502 may be the tap handle with display depicted herein that includes the computing device in FIG. 4. In embodiments, servers 504 and 506 may be any type of computing device, such as the computing device illustrated in FIG. 4. Network 508 may be any type of network capable of facilitating communications between the client device and one or more servers 504 and 506. Examples of such networks include, but are not limited to, LANs, WANs, cellular networks, and/or the Internet.

In embodiments, the various systems and methods disclosed herein may be performed by one or more server devices. For example, in one embodiment, a single server, such as server 504 may be employed to perform the systems and methods disclosed herein. Tap handle device 502 may interact with server 504 via network 508 in send testing results from the device being tested for analysis or storage. In further embodiments, the Tap handle device 502 may also perform functionality disclosed herein, such as by collecting and analyzing testing data.

In alternate embodiments, the methods and systems disclosed herein may be performed using a distributed computing network, or a cloud network. In such embodiments, the methods and systems disclosed herein may be performed by two or more servers, such as servers 504 and 506. Although a particular network embodiment is disclosed herein, one of skill in the art will appreciate that the systems and methods disclosed herein may be performed using other types of networks and/or network configurations.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure described some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
a tap handle comprising:
a housing;
a display disposed in the housing;
a processor in communication with display; and
a remote device input in communication with the processor for receiving a signal from at least one remote sensor; and at least one of
a scale disposed remote from the tap handle, wherein the scale comprises a scale output in communication with the remote device input; and
a position sensor in communication with the processor for detecting a position of the tap handle.

2. The system of claim 1, wherein the tap handle comprises the position sensor.

3. The system of claim 1, further comprising a remote sensor comprising a remote sensor output in communication with the remote device input.

4. The system of claim 3, wherein the remote sensor comprises at least one of a gas pressure sensor, a temperature sensor, a fluid flow sensor, a viscometer, and an air sensor.

5. The system of claim 1, wherein the tap handle further comprises a control input in communication with the processor.

6. The system of claim 1, wherein the position sensor comprises at least one of a tilt sensor, an encoder, a proximity sensor, and an accelerometer.

7. The system of claim 1, further comprising a user interface.

8. The system of claim 7, wherein the user interface comprises a graphic user interface, and wherein the display is adapted to display the graphic user interface.

9. An apparatus comprising:
a housing adapted to be secured to a beverage system tap;
a processor disposed in the housing;
at least one input in communication with the processor; and
a display disposed in the housing and in communication with the processor, the display configured to display information related to a beverage type and information related to a beverage system condition.

10. The apparatus of claim 9, further comprising at least one input in communication with the processor, wherein the beverage system condition is derived by the processor based upon information received from a sensor in communication with the at least one input.

11. The apparatus of claim 10, wherein the sensor is at least one of disposed in the housing and remote from the housing.

12. The apparatus of claim 9, wherein the sensor comprises a plurality of sensors remote from the housing.

13. The apparatus of claim 9, wherein the sensor comprises a plurality of sensors disposed both in the housing and remote from the housing.

14. The apparatus of claim 9, wherein the information related to the beverage type and the information related to the beverage system condition are displayed sequentially.

15. The apparatus of claim 9, wherein the information related to the beverage type and the information related to the beverage system condition are displayed simultaneously.

16. The apparatus of claim 9, wherein the graphic user interface configured to display an alert condition.

17. The apparatus of claim 16, wherein the alert condition is derived by the processor based upon information received from a sensor in communication with the at least one input.

18. A system comprising:
a remote sensor;
an user-actuatable element disposed remote from the remote sensor, the user-actuatable element comprising:
a display;
a processor in communication with display; and
at least one remote device input in communication with the processor for receiving a signal from the remote sensor; and
a scale disposed remote from the user-actuatable element, wherein the scale comprises a scale output in communication with the processor,
wherein the display is configured to dynamically display information about at least one of the scale, a liquid tank disposed on the scale, and a system condition.

19. The system of claim 18, wherein the remote sensor comprises at least one of a fluid flow sensor, a temperature sensor, and a gas pressure sensor.

20. The system of claim 18, wherein the system condition is detected by the remote sensor.
